(19) United States
(12) Patent Application Publication
(10) Pub. No.: US 2022/0048354 A1
(43) Pub. Date: Feb. 17, 2022

(54) CONTROL DEVICE AND CONTROL METHOD FOR CONTROLLING ACTUATING MECHANISM FOR VEHICLE

(71) Applicant: HITACHI ASTEMO, LTD., Hitachinaka-shi, Ibaraki (JP)

(72) Inventor: Yoshinori IKEDA, Hitachinaka-shi, Ibaraki (JP)

(73) Assignee: HITACHI ASTEMO, LTD., Hitachinaka-shi, Ibaraki (JP)

(21) Appl. No.: 17/274,566

(22) PCT Filed: Mar. 13, 2019
(86) PCT No.: PCT/JP2019/010207

§ 371 Date: Mar. 9, 2021

(30) Foreign Application Priority Data
Sep. 21, 2018 (JP) 2018-177366

(51) Int. Cl. B60G 17/0185; B60G 13/08; B60G 17/08; H02M 7/44; H02M 1/36

(52) U.S. Cl. CPC B60G 17/0185; B60G 13/08; B60G 17/08; H02M 7/44; B60G 2800/916; B60G 2202/24; B60G 2500/10; B60G 2600/73; B60G 2800/162; H02M 1/36

(57) ABSTRACT

A control device and a control method for controlling an actuating mechanism for a vehicle according to the present invention are designed to detect whether an abnormality occurs in the voltage application device provided with a booster circuit to generate a boosted voltage to be applied to an electrorheological fluid, and to stop boosting of the booster circuit when an abnormality occurs in the voltage application device for preventing overheating caused by overcurrent flowing to the voltage application device when an abnormality occurs such as short-circuit and ground fault in the voltage application device.

### TECHNICAL FIELD

The present invention relates to a control device and to a control method for an actuating mechanism for a vehicle, using an electrorheological fluid as a working fluid.

### BACKGROUND ART

Patent Document 1 discloses a damper in which an inner space of a cylinder is partitioned by a piston into an outflow chamber and an inflow chamber, each of which is filled with the electrorheological fluid.

### REFERENCE DOCUMENT LIST

### Patent Document

Patent Document 1: JP 2016-515184 A

### SUMMARY OF THE INVENTION

### Problem to be Solved by the Invention

The viscosity of an electrorheological fluid changes in accordance with changes in voltage applied thereto. The damping force of a damper for a vehicle using an electrorheological fluid as the working fluid, for example, is controlled by boosting the source voltage of the onboard battery using the booster circuit including a transformer, and applying the boosted voltage to the electrorheological fluid.

An abnormality, for example, a short-circuit or around fault, which occurs in a voltage application device including the booster circuit, generates heat caused by overcurrent flowing to the voltage application device, leading to failure.

The present invention has been made in light of the foregoing circumstances, and it is an object of the present invention to provide a control device and a control method for controlling an actuating mechanism for a vehicle, which ensures suppression of heat generation caused by overcurrent due to occurrence of an abnormality such as short-circuit and ground fault in the voltage application device including the booster circuit.

### Means for Solving the Problem

The device for controlling an actuating mechanism for a vehicle according to one aspect of the present invention includes an abnormality detection unit for detecting whether an abnormality occurs in the voltage application device provided with a booster circuit for boosting a source voltage to generate a voltage to be applied to the electrorheological fluid, and a boost stopping unit for outputting an instruction to stop boosting of the booster circuit when an abnormality occurs in the voltage application device.

The method for controlling an actuating mechanism for a vehicle according to another aspect of the present invention includes the steps of detecting whether an abnormality occurs in the voltage application device provided with a booster circuit for boosting a source voltage to generate a voltage to be applied to the electrorheological fluid, and outputting an instruction to stop boosting the booster circuit when an abnormality occurs in the voltage application device.

### Effects of the Invention

According to the present invention, in the case of an abnormality in the voltage application device, the boosting of the booster circuit is stopped to suppress generation of excessive heat.

### BRIEF DESCRIPTION OF THE DRAWINGS

FIG. 1 schematically illustrates a suspension system of a vehicle.

FIG. 2 is a circuit diagram illustrating a booster circuit and an abnormality detection unit in detail.

FIG. 3 is a block diagram illustrating a combination of relays, booster circuits, and abnormality detection units.

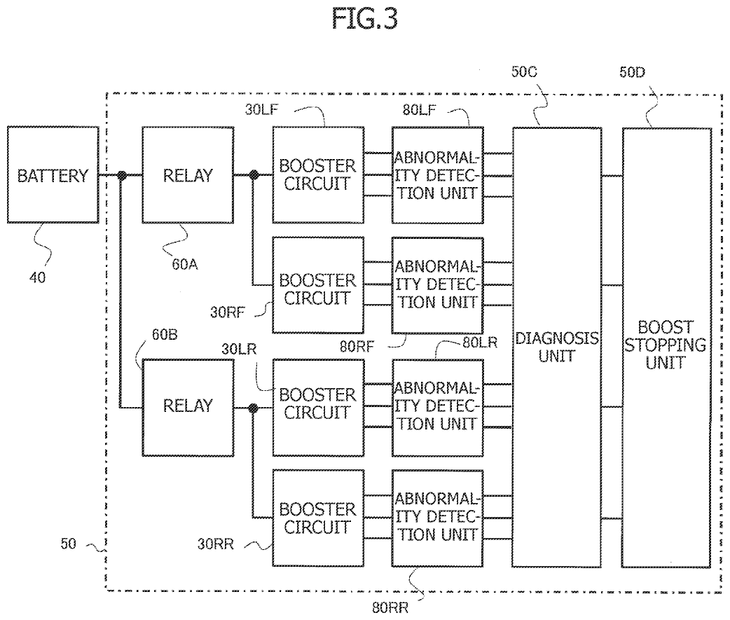

FIG. 4 is a flowchart representing a procedure of a boost stopping process.

FIG. 5 schematically illustrates the suspension system of the vehicle.

FIG. 6 is a flowchart representing a procedure of a boost stopping process.

FIG. 7 is a flowchart representing a procedure of a boost stopping process.

FIG. 8 is a flowchart representing a procedure of a boost stopping process.

### MODE FOR CARRYING OUT THE INVENTION

Hereinafter, an embodiment of a control device and a control method for controlling an actuating mechanism for a vehicle according to the present invention will be described referring to the drawings.

In the embodiment, a damper having a cylinder sealed with the electrorheological fluid used as a working fluid will be described as an aspect of an actuating mechanism for a vehicle. The control device applied to the damper will be described as an aspect of the control device according to the present invention.

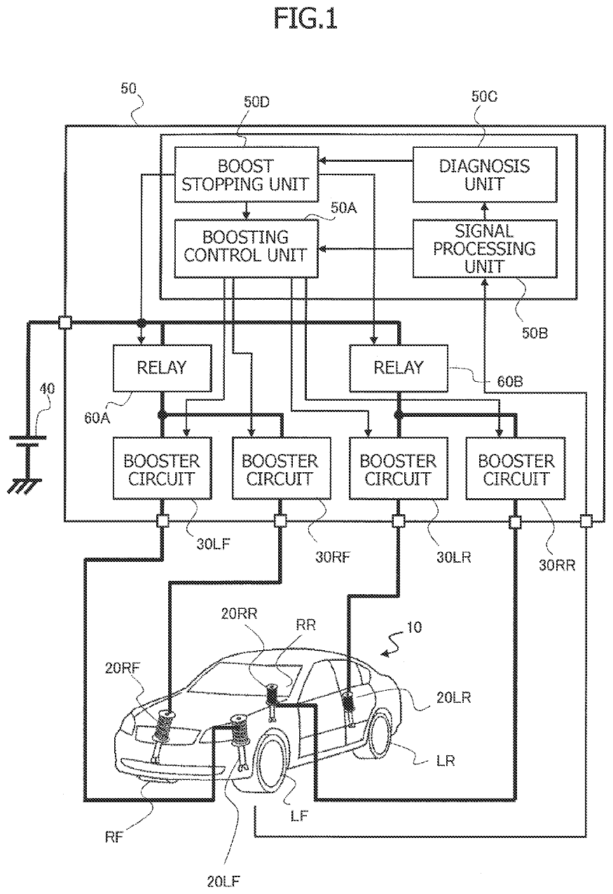

FIG. 1 illustrates a suspension system for a vehicle. Referring to FIG. 1, a vehicle 10 is a four-wheel vehicle including a left front wheel LF, a right front wheel RF, a left rear wheel LR, and a right rear wheel RR. Suspension devices for the respective wheels include dampers 20LF, 20RF, 20LR, and 20RR, respectively.

Each of the dampers 20LF, 20RF, 20LR, and 20RR is structured to have the electrorheological fluid sealed in the cylinder, and to allow damping force to be variable with change in viscosity of the electrorheological fluid in accordance with the applied voltage.

Booster circuits 30LF, 30RF, 30LR, and 30RR supply boosting voltages to dampers 20LF, 20RF, 20LR, and 20RR, respectively. In other words, a combination of a damper and a booster circuit is provided for each of four wheels LF, RF, LR, and RR of vehicle 10.

Booster circuits 30LF, 30RF, 30LR, and 30RR boost source voltages from an onboard battery 40 to generate voltages applied to the electrorheological fluid in dampers 20LF, 20RF, 20LR, and 20RR, respectively.

A control device 50 with a microcomputer controls booster circuits 30LF, 30RF, 30LR, 30RR individually; in other words, it installs software serving as a boosting control unit 50A to individually control the applied voltage to the electrorheological fluid in dampers 20LF, 20RF, 20LR, 20RR, respectively.

Control device 50 includes a signal processing unit 50B which processes signals output from various sensors for detecting operation states of vehicle 10, and conditions of the voltage application device. Boosting control unit 50A controls booster circuits 30LF, 30RF, 30LR, 30RR individually based on various information acquired from signal processing unit 50B.

A power supply line for electrically connecting booster circuits 30LF, 30RF, 30LR, 30RR to onboard battery 40 is provided with a first relay 60A and a second relay 60B each as a power distribution controller for switching between supply and interruption of the source voltage.

Each of first relay 60A and second relay 60B may be either a mechanical relay or a semiconductor relay

An input terminal of first relay 60A is connected to onboard battery 40, and an output terminal thereof is connected to booster circuits 30LF and 30RF in parallel. An input terminal of second relay 60B is connected to onboard battery 40, and an output terminal thereof is connected to booster circuits 30LR and 30RR in parallel.

In the foregoing circuit structure, first relay 60A is a breaking circuit for switching operations between supply and interruption of source voltages to booster circuit 30LF of left front wheel LF and booster circuit 30RF of right front wheel RF simultaneously. Second relay 60B is a breaking circuit for switching operations between supply and interruption of source voltages to booster circuit 30LR of left rear wheel LR and booster circuit 30RR of right rear wheel RR simultaneously.

Booster circuits 30LF, 30RF, 30LR, 30RR are divided into a first group of booster circuit 30LF of left front wheel LF and booster circuit 30RF of right front wheel RF, and a second group of booster circuit 30LR of left rear wheel LR and a booster circuit 30RR of right rear wheel RR.

First relay 60A interrupts the power supply to booster circuits 30LF, 30RF of the first group simultaneously, and second relay 60B interrupts the power supply to booster circuits 30LR, 30RR of the second group simultaneously.

Control device 50 includes a diagnosis unit 50C which diagnoses presence or absence of abnormality, such as a ground fault and a short-circuit, in the voltage application devices including booster circuits 30LE 30RF, 30LR, 30RR, respectively, based on various information acquired by signal processing unit 50B. If diagnosis unit 50C diagnoses that an abnormality has occurred, a boost stopping unit 50D outputs a continuity interruption instruction to relays 60A, 60B, and booster circuits 30LF, 30RF, 30LR, 30RR individually to stop boosting booster circuits 30LF, 30RF, 30LR, 30RR.

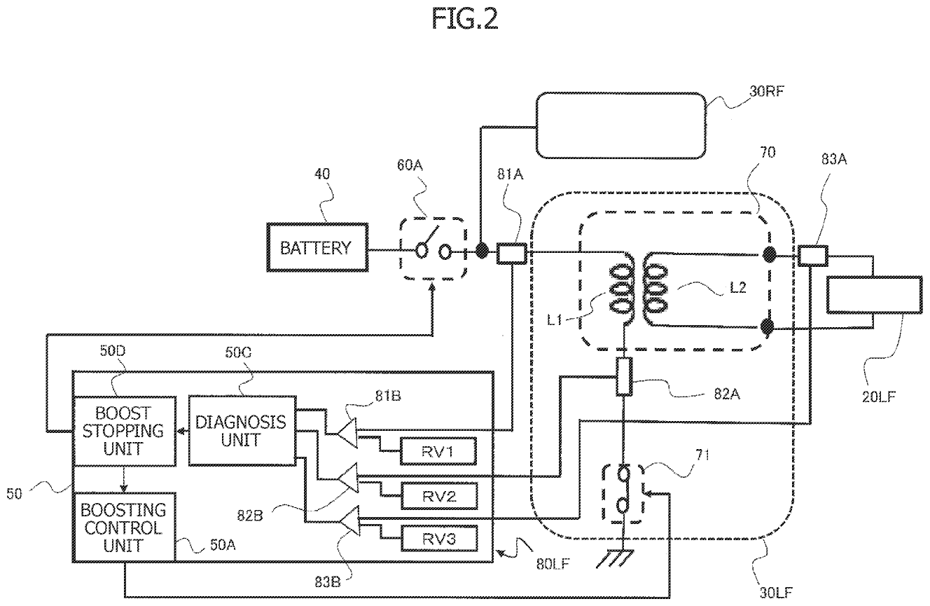

FIG. 2 illustrates a detailed circuit structure of booster circuit 30LF among booster circuits 30LF, 30RF, 30LR, 30RR.

Explanations of booster circuits 30RF, 30LR, 30RR will be omitted as they are structured similarly to booster circuit 30LF.

Booster circuit 30LF includes a transformer 70 constituted by a primary coil L1 at an input side, and a secondary coil L2 at an output side, and a semiconductor switching, element 71 such as a MOSFET connected between primary coil L1 and ground GILD in series.

Semiconductor switching element 71 is a power distribution controller for controlling continuity and interrupting continuity to primary coil L1.

Source voltage is supplied to primary coil L1 from onboard battery 40 via first relay 60A. The voltage generated by secondary coil L2 is applied to the electrorheological fluid in damper 20LF.

Boosting control unit 50A of control device 50 executes a PWM (Pulse Width Modulation) control to semiconductor switching element 71 of booster circuit 30LF to adjust the boosting voltage to be applied to the electrorheological fluid.

An abnormality detection unit 80LF is further provided for detecting whether an abnormality occurs in the voltage application device including a source voltage line to booster circuit 30LF, and a line for applying the boosting voltage from booster circuit 30LF to the electrorheological fluid.

Abnormality detection unit 80LF includes a first voltage division circuit 81A which generates a voltage proportional to the voltage between first relay 60A and primary coil L1, a first comparator 81B which compares the voltage generated by first voltage division circuit 81A with a first reference voltage RV1 as a first threshold voltage, a second voltage division circuit 82A which generates a voltage proportional to the voltage between primary coil L1 and semiconductor switching element 71, a second comparator 82B which compares the voltage generated by second voltage division circuit 82A with a second reference voltage RV2, a third voltage division circuit 83A which generates a voltage proportional to the boosting voltage to be applied to the electrorheological fluid, and a third comparator 83B which compares the voltage generated by third voltage division circuit 83A with a third reference voltage RV3.

Diagnosis unit 50C of control device 50 acquires information indicating comparison results of comparators 81B to 83B to diagnose presence or absence of abnormality in the voltage application device including booster circuit 30LF, in other words, a damping force adjustment device of damper 20LF.

First comparator 81B determines a voltage level between first relay 60A and primary coil Ll to output information indicating whether or not the voltage supplied to primary coil L1 is normal, in other words, whether or not an abnormality, such as a disconnection and a ground fault, has occurred in the source voltage supply line to primary coil L1.

That is, when first relay 60A is in the ON state and the voltage supplied to primary coil L1 is normal, first reference voltage RV1 is set to a voltage value as a lower limit of the voltage generated by first voltage division circuit 81A. When the voltage generated by first voltage division circuit 81A becomes lower than first reference voltage RV1, first comparator 81B outputs a signal indicating abnormality in the source voltage supply line to primary coil L1.

Second comparator 82B determines a voltage level between primary coil L1 and semiconductor switching element 71 to output information indicating whether or not the line downstream from primary coil Ll is normal; in other words, whether or not an abnormality, such as a ground fault owing to short-circuit of semiconductor switching element 71, has occurred in the line downstream from primary coil L1.

That is, when the line downstream from primary coil L1 is normal in an OFF state of the PWM control to semiconductor switching element 71, second reference voltage RV2 is set to a voltage value as a lower limit of the voltage generated by second voltage division circuit 82A. When the voltage generated by second voltage division circuit 82A becomes lower than second reference voltage RV2, second comparator 82B outputs a signal indicating abnormality in the line downstream from primary coil L1.

Alternatively, when the line downstream from primary coil L1 is normal in a stopped state of the PWM control to semiconductor switching element 71, second reference voltage RV2 is set to a voltage value as the lower limit of the voltage generated by second voltage division circuit 82A. When the voltage generated by second voltage division circuit 82A becomes lower than second reference voltage RV2, second comparator 82B outputs a signal indicating abnormality in the line downstream from primary coil L1.

Third comparator 83B determines a boosted voltage level applied to the electrorheological fluid to output information indicating whether or not an abnormality has occurred in secondary coil L2 or the line for supplying the boosted voltage to the electrorheological fluid.

That is, when the boosted voltage applied to the electrorheological fluid is normal, third reference voltage RV3 is set to a voltage value as a lower limit of the voltage generated by third voltage division circuit 83A. When the voltage generated by third voltage division circuit 83A becomes lower than third reference voltage RV3, third comparator 83B outputs a signal indicating abnormality in secondary coil L2 or the line for supplying the boosted voltage to the electrorheological fluid.

Booster circuits 30LF, 30RF, 30LR, 30RR include abnormality detection units 80LF, 80RF, 80LR, 80RR, respectively.

Diagnosis unit 50C of control device 50 acquires comparison results of the voltage level from each of abnormality detection units 80LF, 80RF, 80LR, 80RR via signal processing unit 50B.

If all values output from three comparators 81B to 83B of abnormality detection unit 80LF indicate normal states, diagnosis unit 50C determines that the voltage application device including booster circuit 30LF is normal. If one of the values output from three comparators 81B to 83B of abnormality detection unit 80LF indicates the abnormal state, diagnosis unit 50C determines that the voltage application device including booster circuit 30LF is abnormal.

Diagnosis unit 50C also determines whether an abnormality occurs in the voltage application device including booster circuit 30RF, the voltage application device including booster circuit 30LR, and the voltage application device including booster circuit 30RR.

In the case of an abnormality in the voltage application device, boost stopping unit 50D for acquiring information of diagnosis results of diagnosis unit 50C controls the power distribution controller of the voltage application device so as to stop boosting the booster circuits 30LF, 30RF, 30LR, 30RR of the voltage application devices in which an abnormality has occurred.

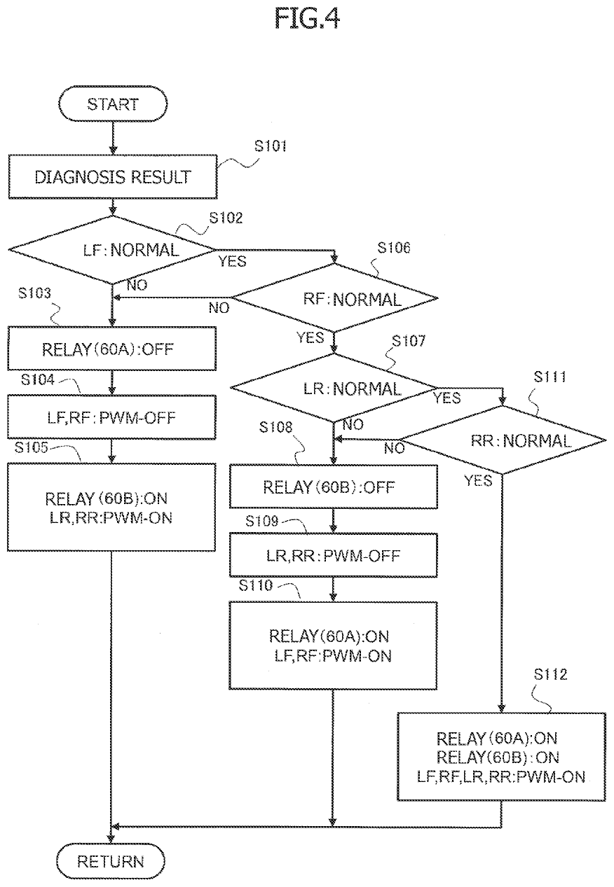

FIG. 4 is a flowchart representing a procedure of boost stopping control executed by boost stopping unit 50D of control device 50.

In step S101, control device 50 reads the diagnosis result of diagnosis unit 50C that is, information indicating presence or absence of voltage abnormality in each voltage application device of the respective wheels.

Control device 50 proceeds the process to step S102 to determine whether or not the voltage application device including booster circuit 30LF of left front wheel LF is normal.

If the voltage application device of left front wheel LF has abnormality, control device 50 proceeds the process to step S103 to output an OFF instruction to first relay 60A.

Control device 50 turns first relay 60A off, that is, interrupts continuity to interrupt power supply to booster circuit 30LF of left front wheel LF and booster circuit 30RF of right front wheel RF. Control device 50 then stops boosting both booster circuits 30LF 30RF, in other words, stops executing damping force control to dampers 20LF, 20RF of both front wheels LF, RF, respectively.

Control device 50 interrupts power supply to the voltage application device including booster circuit 30LF to prevent overheating caused by overcunent flowing to booster circuit 30LF owing to an abnormality such as a short-circuit and a ground fault.

Subsequently in step S104, control device 50 outputs an instruction to maintain OFF states of semiconductor switching elements 71 of booster circuits 30LF and 30RF, specifically, the instruction to set the ON-duty ratio to 0%.

Control device 50 controls to turn first relay 60A off, and semiconductor switching elements 71 of booster circuits 30LF and 30RF off. If, for example, semiconductor switching element 71 undergoes breakdown due to a short-circuit, first relay 60A is turned off to interrupt power supply to booster circuits 30LF and 30RF. On the other hand, if first relay 60A undergoes breakdown due to a short-circuit, semiconductor switching elements 71 are turned off to interrupt power supply to primary coils LI of booster circuits 30LF and 30RF.

Control device 50 proceeds the process to step S105 to maintain an ON state of second relay 60B, and to continue execution of the PWM control to semiconductor switching elements 71 of booster circuits 30LR and 30RR while continuously executing the damping force control to dampers 20LR, 20RR of both rear wheels LR, RR through voltage application to the electrorheological fluid.

Meanwhile, in step S102, if it is determined that the voltage application device including booster circuit 30LF of left front wheel LF is normal, control device 50 proceeds the process to step S106.

In step S106, control device 50 determines whether or not the voltage application device including booster circuit 30RF of right front wheel RF is normal.

If the voltage application device including booster circuit 30RF of right front wheel RF is abnormal, control device 50 proceeds the process to step S103 in a similar way to the case in which the voltage application device of left front wheel LF is abnormal.

If either the voltage application device including booster circuit 30LF of left front wheel LF or the voltage application device including booster circuit 30RF of right front wheel RF has an abnormality, control device 50 stops boosting both booster circuits 30LF, 30RF to stop executing the damping force control to dampers 20LF, 20RF of both front wheels LF, RF.

Meanwhile, if the voltage application device including booster circuit 30LF of left front wheel LF, and the voltage application device including booster circuit 30RF of right front wheel RF are normal, control device 50 proceeds the process from step S106 to step S107.

In step S107, control device 50 determines whether or not the voltage application device including booster circuit 30LR of left rear wheel LR is normal.

If the voltage application device of left rear wheel LR is abnormal, control device 50 proceeds the process to step S108.

In step S108, control device 50 outputs an OFF instruction to second relay 60B to be turned off, that is, to interrupt continuity so as to interrupt power supply to booster circuit 30LR of left rear wheel LR and booster circuit 30RR of right rear wheel RR. Boosting of both booster circuits 30LR, 30RR is then stopped.

Control device 50 interrupts power supply to the voltage application device including booster circuit 30LR so as to prevent overheating caused by overcurrent flowing to booster circuit 30LR of the voltage application device having abnormality

Subsequently in step S109, control device 50 outputs an instruction to hold off states of semiconductor switching elements 71 of booster circuits 30LR and 30RR, for example, the instruction to set the On-duty ratio to 0%.

Control device 50 proceeds the process to step S110 to maintain an ON state of first relay 60A, and to continue execution of the PWM control to semiconductor switching elements 71 of booster circuits 30LF and 30RF while continuously executing the damping force control to damper 20LF of left front wheel LF and the damper 20RF of right front wheel

RF through voltage application to the electrorheological fluid.

If the voltage application device of left rear wheel LR is normal, control device 50 proceeds the process from step S107 to step S111.

In step S111, control device 50 determines whether or not the voltage application device including booster circuit 30RR of right rear wheel RR is normal.

If the voltage application device of right rear wheel RR is abnormal, control device 50 proceeds the process to step S108 in a similar way to the case in which the voltage application device of left rear wheel LR is abnormal.

If either the voltage application device of left rear wheel LR or the voltage application device of right rear wheel RR has an abnormality, control device 50 stops the boosting of booster circuits 30LR, 30RR of both rear wheels LR, RR to stop executing the damping force control to dampers 20LR, 20RR of both rear wheels LR, RR. In step S1 11, if it is determined that the voltage application device of right rear wheel

RR is normal, that is, all the voltage application devices of four wheels are normal, control device 50 proceeds the process to step S112.

Control device 50 normally executes the damping force control to control the damper in step S112.

Specifically, control device 50 holds ON states of first relay 60A and second relay 60B, and executes the PWM control to semiconductor switching elements 71 of booster circuits 30LF, 30RF, 30LR, 30RR so as to execute the damping force control to dampers 20LF, 20RF, 20LR, 20RR through voltage application to the electrorheological fluid.

In the embodiment, when the voltage application device has an abnormality, control device 50 executes the control to turn relays 60A, 60B off and semiconductor switching elements 71 off.

The structure of control device 50 is not limited to executing the control to turn relays 60A 60B off and semiconductor switching elements 71 off, but is also allowed to execute the OFF-control for at least one of relays 60A, 60B, and semiconductor switching elements 71 when an abnormality occurs in the voltage application device.

An example of the structure will be described hereinafter.

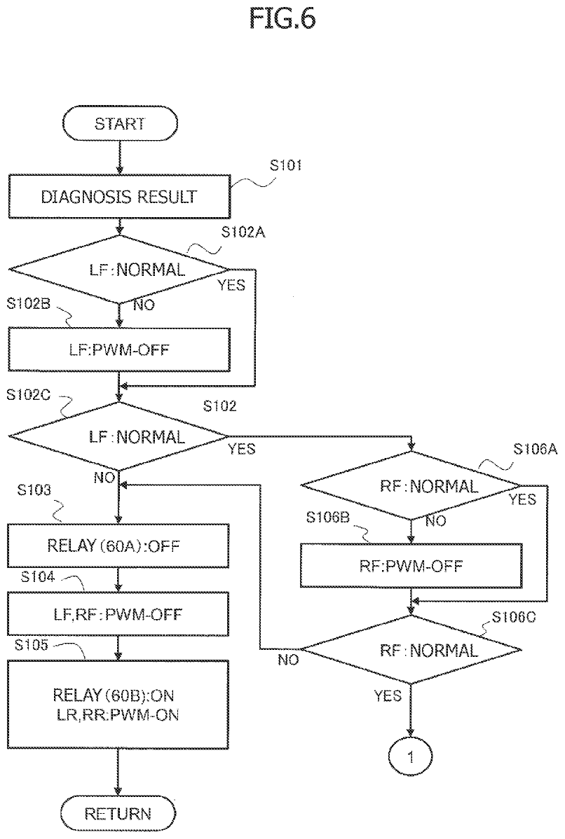

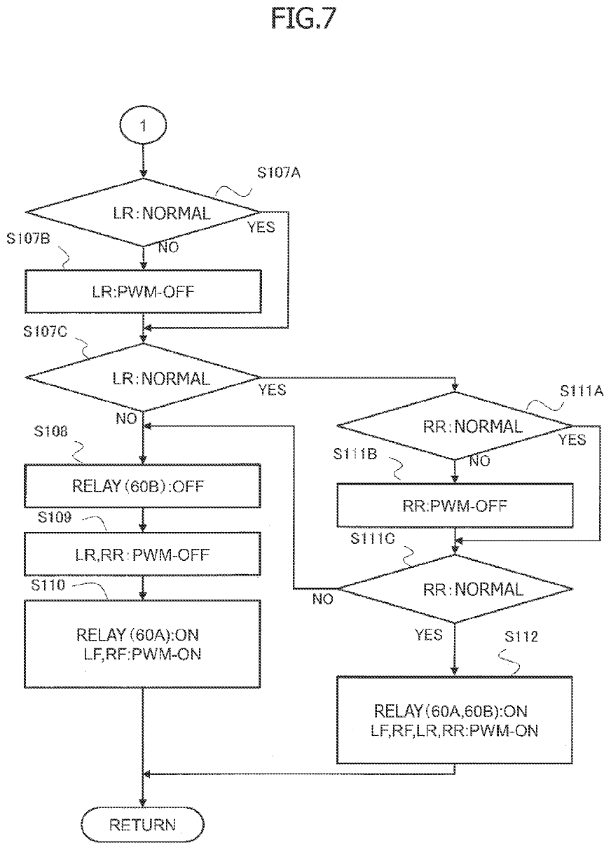

FIG. 6 and FIG. 7 are flowcharts representing the procedure of boost stopping control executed by boost stopping unit 50D of control device 50.

In step S101, control device 50 reads diagnosis result of diagnosis unit 50C, that is, information indicating presence or absence of a voltage abnormality in each voltage application device of the respective wheels.

Control device 50 proceeds the process to step S 102A to determine whether or not the voltage application device of left front wheel LF is normal.

If the voltage application device of left front wheel LF has an abnormality, control device 50 proceeds the process to step S102B for outputting an instruction to hold an OFF-state of semiconductor switching element 71 of booster circuit 30LF, for example, the instruction to set the ON-duty ratio to 0%.

Control device 50 turns semiconductor switching element 71 of booster circuit 30LF off, that is, interrupts power supply to stop boosting the booster circuit 30LF of left front wheel LF, in other words, to stop executing the damping force control to damper 20LF of left front wheel LF.

Control device 50 interrupts power supply to the voltage application device to prevent overheating caused by overcurrent flowing to the voltage application device owing to an abnormality such as a short-circuit and a ground fault. In the foregoing state, power supply to booster circuit 30RF of right front wheel RF is continued to execute the PWM control to semiconductor switching element 71 continuously. The damping force control to damper 20RF of right front wheel RF is continuously executed through voltage application to the electrorheological fluid.

Control device 50 proceeds the process to step S102C to determine whether or not booster circuit 30LF of left front wheel LF is normal.

If booster circuit 30LF of left front wheel LF has an abnormality, control device 50 proceeds the process to step S103 to output an OFF instruction to first relay 60A.

Control device 50 turns first relay 60A off, that is, interrupts continuity to interrupt power supply to booster circuit 30LF of left front wheel LF and booster circuit 30RF of right front wheel RF to stop boosting both booster circuits 30LF, 30RF, in other words, stop executing the damping force control to dampers 20LF, 20RF of both front wheels LF,

Control device 50 interrupts power supply to the voltage application device including booster circuit 30LF to prevent overheating caused by overcurrent flowing to booster circuit 30LF due to an abnormality such as short-circuit and ground fault.

Subsequently, in step S104, control device 50 outputs an instruction to maintain OFF states of semiconductor switching elements 71 of booster circuits 30LF and 30RF, for example, the instruction to set the On-duty ratio to 0%.

Control device 50 controls to turn first relay 60A off, and semiconductor switching elements 71 of booster circuits 30LF and 30RF off If, for example, semiconductor switching element 71 undergoes breakdown due to short-circuit, first relay 60A is turned off to interrupt power supply to booster circuits 30LF and 30RF. Meanwhile, if first relay 60A undergoes breakdown due to short-circuit, semiconductor switching element 71 is turned off to interrupt power supply to primary coils Ll of booster circuits 30LF and 30RF.

Control device 50 proceeds the process to step S105 to hold an ON state of second relay 60B, and to continue execution of the PWM control to semiconductor switching elements 71 of booster circuits 30LR and 30RR while continuously executing the damping force control to dampers 20LR 20RR of both rear wheels LR, RR through voltage application to the electrorheological fluid.

In addition, in step S102C, if it is determined that booster circuit 30LF of left front wheel LF is normal, control device 50 proceeds the process to step S106A.

In step S106A, control device 50 determines whether or not the voltage application device of right front wheel RF is normal.

If the voltage application device of right front wheel RF has an abnormality, control device 50 proceeds the process to step S106B in a similar way to the case in which the voltage application device of left front wheel LF is abnormal. If the voltage application device has an abnormality, control device 50 turns semiconductor switching element 71 of booster circuit 30RF off, that is, interrupts continuity to stop boosting booster circuit 30RF of right front wheel RF; in other words, to stop executing the damping force control to damper 20RF of right front wheel RF.

Control device 50 proceeds the process to step S106C to determine whether or not booster circuit 30RF of right front wheel RF is normal.

If booster circuit 30RF of right front wheel RF is abnormal, control device 50 proceeds the process to step S103 in a similar way to the case in which booster circuit 30LF of left front wheel LF is abnormal.

If either the voltage application device including booster circuit 30LF of left front wheel LF or the voltage application device including booster circuit 30RF of right front wheel RF has an abnormality, control device 50 stops boosting both booster circuits 30LF, 30RF to stop executing the damping force control to dampers 20LF, 20RF of both front wheels LF. RF.

In addition, if the voltage application device including booster circuit 30LF of left front wheel LF, and the voltage application device including booster circuit 30RF of right front wheel RF are normal, control device 50 proceeds the process from step S106C to step S107A.

In step S107A, control device 50 determines whether or not the voltage application device of left rear wheel LR is normal.

If the voltage application device of left rear wheel LR is abnormal, control device 50 proceeds the process to step S107B.

In step S107B, control device 50 outputs an instruction to maintain an OFF state of semiconductor switching element 71 of booster circuit 30LR, for example, the instruction to set the ON-duty ratio to 0% so as to stop boosting booster circuit 30LR of left rear wheel LR, in other words, stop executing the damping force control to damper 20LR of left rear wheel LR.

Control device 50 proceeds the process to step S107C to determine whether or not booster circuit 30LR of left rear wheel LR is normal.

If booster circuit 30LR of left rear wheel LR is abnormal, control device 50 proceeds the process to step S108.

In step S108, control device 50 outputs an OFF instruction to second relay 60B to be turned off, that is, to interrupt continuity to interrupt power supply to booster circuit 30LR of left rear wheel LR and booster circuit 30RR of right rear wheel RR so as to stop boosting both booster circuits 30LR, 30RR.

Control device 50 interrupts power supply to the voltage application device including booster circuit 30LR to prevent overheating caused by overcurrent flowing to booster circuit 30LR of the voltage application device having an abnormality.

Subsequently in step S109, control device 50 outputs an instruction to maintain OFF states of semiconductor switching elements 71 of booster circuits 30LR and 30RR, for example, the instruction to set the ON-duty ratio to 0%.

Control device 50 proceeds the process to step S110 to maintain an ON state of first relay 60A, and to continue execution of the PWM control to semiconductor switching elements 71 of booster circuits 30LF and 30RF while continuously executing the damping force control to damper 20LF of left front wheel LF and damper 20RF of right front wheel RF through voltage application to the electrorheological fluid.

If the voltage application device of left rear wheel LR is normal, control device 50 proceeds the process from step S107C to step S111A.

In step S111A, control device 50 determines whether or not the voltage application device of right rear wheel RR is normal.

If the voltage application device of right rear wheel RR is abnormal, control device 50 proceeds the process to step S 111B in a similar way to the case in which the voltage application device of left rear wheel LR is abnormal.

In step S111B, control device 50 outputs an instruction to hold an off state of semiconductor switching element 71 of booster circuit 30RR, for example, the instruction to set the on-duty ratio to 0% so as to stop boosting booster circuit 30RR of right rear wheel RR; in other words, stop executing the damping force control to damper 20RR of right rear wheel RR.

Control device 50 proceeds the process to step S111C to determine whether or not booster circuit 30RR of right rear wheel RR is normal.

If booster circuit 30RR of right rear wheel RR is abnormal, control device 50 proceeds the process to step S108.

If either booster circuit 30LR of left rear wheel LR or booster circuit 30RR of right rear wheel RR has an abnormality, control device 50 stops boosting of booster circuits 30LR, 30RR of both rear wheels LR, RR to stop executing the damping force control to dampers 20LR, 20RR of both rear wheels LR, RR.

In step S111C, if it is determined that booster circuit 30RR of right rear wheel RR is normal, that is, that all the voltage application devices of four wheels are normal, control device 50 proceeds the process to step S112.

In step S112, control device 50 normally executes the damping force control to dampers.

Specifically, control device 50 maintains ON states of first relay 60A and second relay 60B, and executes the PWM control to semiconductor switching elements 71 of booster circuits 30LF, 30RF, 30LR, 30RR so as to execute the damping force control to dampers 20LF, 20RF, 20LR, 20RR through voltage application to the electrorheological fluid.

If the voltage application device has an abnormality, control device 50 preferentially executes the OFF control to semiconductor switching element 71, for example, so as to allow relays 60A, 60B to be turned off when continuity to booster circuits 30LF, 30RF, 30LR, 30RR cannot be interrupted.

Concerning arrangement of relays, it is possible to provide four relays for power supply to booster circuits 30LF, 30RF, 30LR, 30RR, respectively, provide one relay at a part for power supply to all booster circuits 30LF, 30RF, 30LR 30RR, or provide the relay for either each of the booster circuits, or each of grouped circuits. Provision of relays 60A, 60B for each group including two wheels allows the damping force control to be continuously executed by continuing power supply to the group having the voltage application device with no abnormality.

In the embodiment, four wheels are divided into a first group as a front-wheel group including two front wheels LF, RF, and a second group as a rear-wheel group including two rear wheels LR, RR. If the voltage application device of the front-wheel group has an abnormality, the damping force control to the two front wheels is stopped while continuously executing the damping force control to the two rear wheels. If the voltage application device of the rear-wheel group has an abnormality; the damping force control to the two rear wheels is stopped while continuously executing the damping force control to the two front wheels. Alternatively, four wheels may be divided into a first group as a left-wheel group including left front and left rear wheels LF, LR, and a second group as a right-wheel group including right front and right rear wheels RF, RR. If the voltage application device of the left-wheel group has an abnormality, the damping force control to the two left wheels is stopped while continuously executing the damping force control to two right wheels. If the voltage application device of the right-wheel group has an abnormality, the damping force control to the two right wheels is stopped while continuously executing the damping force control to two left wheels.

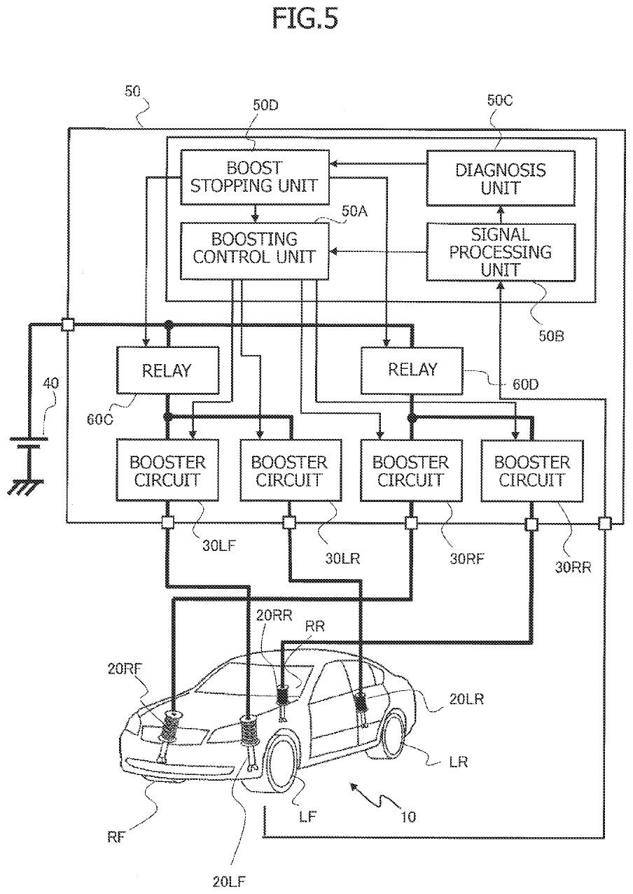

FIG. 5 illustrates a system in which relays 60C, 60D and booster circuits 30LF, 30RF, 30LR, 30RR are combined when the four wheels are divided into the left-wheel group including left front and left rear wheels LF, LR, and the right-wheel group including right front and right rear wheels RF RR.

The system as illustrated in FIG. 5 is configured to supply battery power to booster circuit 30LF of left front wheel LF and booster circuit 30LR of left rear wheel LR via first relay 60C, and supply battery power to booster circuit 30RF of right front wheel RF and booster circuit 30RR of right rear wheel RR via second relay 60D.

If the voltage application device of left front wheel LF or left rear wheel LR has an abnormality, control device 50 turns first relay 60C off, and further turns semiconductor switching elements 71 of booster circuits 30LF and 30LR off to stop boosting booster circuits 30LF and 30LR. In the foregoing state, control device 50 maintains an ON state of second relay 60D to continuously execute the PWM control to semiconductor switching elements 71 of booster circuits 30RF and 30RR.

If the voltage application device of right front wheel RF or right rear wheel RR has an abnoimality, control device 50 turns second relay 60D off, and further turns semiconductor switching elements 71 of booster circuits 30RF and 30RR off to stop boosting booster circuits 30RF and 30RR. In the foregoing state, control device 50 maintains an ON state of first relay 60C to continuously execute the PWM control to semiconductor switching elements 71 of booster circuits 30LF and 30LR.

In addition to a first pattern for dividing the four wheels into the front-wheel group and the rear-wheel group, and a second pattern for dividing the four wheels into the left-wheel group and the right-wheel group as the pattern for dividing the four wheels into two groups each including two wheels, there may be a third pattern for dividing the four wheels into a first group including left front wheel LF and right rear wheel RR, and a second group including right front wheel RF and left rear wheel LR.

The rolling generated when stopping the damping force control to one of the groups of the third pattern will become greater than the one generated in each case of the first and the second patterns. The magnitude of the rolling may be evaluated based on a roll rate as the value derived from dividing the roll moment around the roll axis under the centrifugal force in turning by the roll angle at that time.

That is, the damping force control system in which the four wheels are grouped in accordance with the first pattern or the second pattern is configured to stop the damping force control to the group having the abnormal voltage application device so as to prevent deterioration in turning operability when continuously executing the damping force control to the group having the normal voltage application device.

Technical concepts of the foregoing embodiment may be freely combined so long as there is no conflict. The present invention has been specifically described with reference to the preferred embodiment. It will be easily understood by those skilled in the art that it is possible to provide various modifications based on basic technical concepts and teachings of the present invention.

If the damping force control to one of the two groups is stopped while continuously executing the damping force control to the other group, control device 50 allows switching of a target damping force, in other words, an application voltage instruction value of the other group to the target damping force for two-wheel control, which is different from the value for executing the damping force control to the four wheels.

Examples will be described hereinafter.

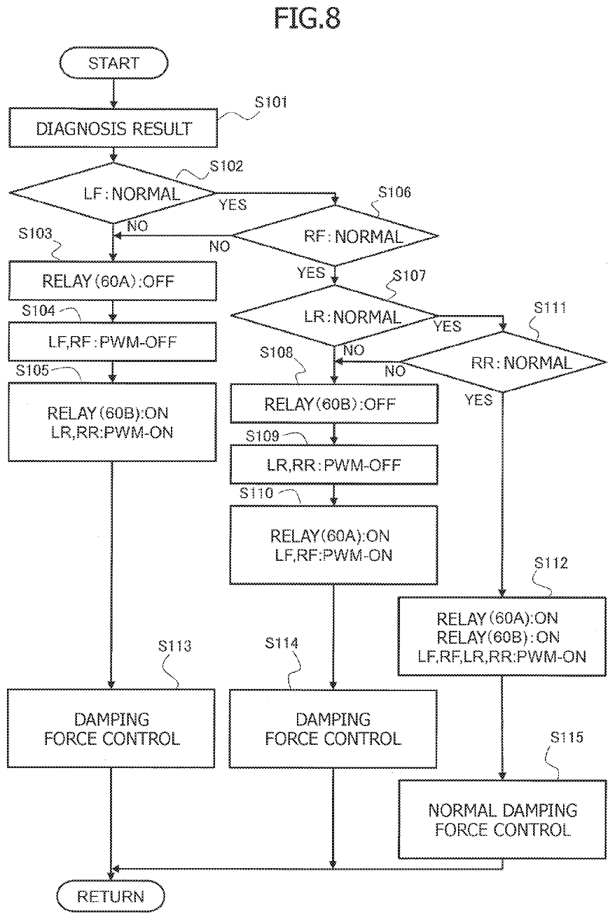

FIG. 8 is a flowchart representing a procedure of boost stopping control executed by boosting control unit 50A and boost stopping unit 50D of control device 50.

The flowchart as illustrated in FIG. 8 is derived from adding steps S113, S114, S115 of the boosting control executed by boosting control unit 50A to the procedure of boost stopping control executed by boost stopping unit 50 of control device 50 as illustrated in FIG. 4.

If the damping force control to both front wheels LF, RF is stopped in step S104, control device 50 executes the 2-wheel damping force control while having the damping force control to both front wheels LF, RF stopped in step S113.

If the damping force control to both rear wheels LR, RR is stopped in step S109, control device 50 executes the 2-wheel damping force control while having the damping force control to both rear wheels LR, RR in step S114.

Based on information from signal processing unit 50B for processing signals output from various sensors for detecting operation states and conditions of the electrorheological fluid in the voltage application device, boosting control unit 50A outputs a damping force target value so as to control booster circuits 30LF, 30RF, 30LR, 30RR.

The 2-wheel damping force control restricts upper and lower limit and change rates to calculate and output the damping force target value in accordance with damping force characteristics of the damper that undergoes breakdown so that vehicle behavior is stabilized even in the case of failure.

Technical concepts in the foregoing embodiment may be freely combined so long as there is no conflict.

The present invention has been specifically described with reference to the preferred embodiment. It will be easily understood by those skilled in the art that it is possible to provide various modifications based on basic technical concepts and teachings of the present invention.

For example, abnormality detection unit 80 is capable of detecting an abnormality in the voltage application device based on voltage measurement values, and also detecting an abnormality in the voltage application device based on measurement values of current and temperature. It is further possible to detect an abnormality in the voltage application device based on the value derived from combining multiple properties selected from voltage, current, and temperature.

When stopping the damping force control to some of the wheels, control device 50 is capable of notifying the driver of vehicle 10 of an abnormality in the damping force control of the damper using a light and a display.

The actuating mechanism for vehicle using the electrorheological fluid as the working fluid is not limited to the damper. The control device is capable of stopping boosting of the booster circuit when an abnormality occurs in the voltage application device in the actuating mechanism for a vehicle, such as a clutch and a brake for transferring power using a medium such as the electrorheological fluid.

### REFERENCE SYMBOL LIST

10 Vehicle
20LF, 20RF, 20LR, 20RR Damper
30LF, 30RF, 30LR, 30RR Booster circuit
40 Onboard battery
50 Control device
50A Boosting control unit
50B Signal processing unit
50C Diagnosis unit
50D Boost stopping unit
60A First relay
60B Second relay
70 Transformer
71 Semiconductor switching element
80LF, 80RF, 80LR, 80RR Abnormality detection unit

1. A control device for controlling an actuating mechanism for a vehicle, the actuating mechanism for a vehicle using an electrorheological fluid as a working fluid, the actuating mechanism including a voltage application device provided with a booster circuit for boosting a source voltage and for generating a voltage to be applied to the electrorheological fluid, the control device comprising:
an abnormality detection unit for detecting whether an abnormality occurs in the voltage application device; and
a boost stopping unit that outputs a command to stop boosting of the booster circuit when an abnormality occurs in the voltage application device.

2. The control device for controlling an actuating mechanism for a vehicle according to claim 1, wherein:
the voltage application device comprises a relay provided on a source voltage supply line to the booster circuit; and
the boost stopping unit outputs a command to turn the relay off as a command to stop boosting of the booster circuit when an abnormality occurs in the voltage application device.

3. The control device for controlling an actuating mechanism for a vehicle according to claim 1, wherein:
the booster circuit comprises a transformer having a primary coil and a secondary coil, and a switching element connected to the primary coil in series, and
the boost stopping unit outputs a command to turn the switching element off as a command to stop boosting of the booster circuit when an abnormality occurs in the voltage application device.

4. The control device for controlling an actuating mechanism for a vehicle according to claim 1, wherein:
the booster circuit comprises a transformer having a primary coil and a secondary coil, and
the abnormality detection unit detects whether an abnormality occurs in a voltage downstream of the primary coil.

5. The control device for controlling an actuating mechanism for a vehicle according to claim 1, wherein the abnormality detection unit detects whether an abnormality occurs in a voltage in a source voltage supply line to the booster circuit.

6. The control device for controlling an actuating mechanism for a vehicle according to claim 1, wherein the abnormality detection unit detects whether an abnormality occurs in a voltage to be applied to the electrorheological fluid.

7. The control device for controlling an actuating mechanism for a vehicle according to claim 1, wherein:
the actuating mechanism for a vehicle is a damper in which an inside of a cylinder is filled with the electrorheological fluid, the damper is combined with the booster circuit and is provided to each of four wheels of the vehicle, the four wheels divided into two groups, each group including two wheels, and
when an abnormality occurs in the voltage application device at one of the wheels, the boost stopping unit outputs a command to stop boosting of the booster circuit of the wheel at which the abnormality occurs in the voltage application device, and outputs a command to stop boosting of the booster circuit of the other wheel belonging to the same group as the wheel at which the abnormality occurs in the voltage application device.

8. The control device for controlling an actuating mechanism for a vehicle according to claim 7, wherein the boost stopping unit continues boosting of the booster circuit of two wheels in the other group different from the group in which the boosting of the booster circuit is stopped.

9. The control device for controlling an actuating mechanism for a vehicle according to claim 8, wherein:
the actuating mechanism for a vehicle comprises a first relay for collectively interrupting source voltage supply to the two booster circuits of a first group as one of the two groups, and a second relay for collectively interrupting the source voltage supply to the two booster circuits of a second group as the other of the two groups, and
the boost stopping unit turns the first relay off when an abnormality occurs in the voltage application device of the first group, and turns the second relay off when an abnormality occurs in the voltage application device of the second group.

10. The control device for controlling an actuating mechanism for a vehicle according to claim 7, wherein the groups comprise the first group including a left front wheel and a right front wheel, and the second group including a left rear wheel and a right rear wheel.

11. The control device for controlling an actuating mechanism for a vehicle according to claim 7, wherein the groups comprise the first group having a left front wheel and a left rear wheel, and the second group having a right front wheel and a right rear wheel.

12. A control method for controlling an actuating mechanism for a vehicle, in which the actuating mechanism using an electrorheological fluid as a working fluid, the actuating mechanism including a voltage application device provided with a booster circuit for boosting a source voltage and for generating a voltage to be applied to the electrorheological fluid, the control method comprising the steps of:
detecting whether an abnormality occurs in the voltage application device; and
outputting a command to stop boosting of the booster circuit when an abnormality occurs in the voltage application device.

13. The control method for controlling an actuating mechanism for a vehicle according to claim 12, wherein:
the voltage application device comprises a relay provided on a source voltage supply line to the booster circuit, and a command to turn the relay off is output as a command to stop boosting of the booster circuit when an abnormality occurs in the voltage application device.

14. The control method for controlling an actuating mechanism for a vehicle according to claim 12, wherein:
the booster circuit comprises a transformer having a primary coil and a secondary coil, and
a switching element connected to the primary coil in series, and
a command to turn the switching element off is output as a command to stop boosting of the booster circuit when an abnormality occurs in the voltage application device.
